(19) United States
(12) Patent Application Publication
(10) Pub. No.: US 2026/0203524 A1
(43) Pub. Date: Jul. 16, 2026

(54) ARTIFICIAL INTELLIGENCE MULTI-AGENT SYSTEM FOR DECISION SUPPORT

(71) Applicant: SAP SE, Walldorf (DE)

(72) Inventors: Markus KRUG, Berlin (DE); Tisha ANDERS, Berlin (DE); Cornelius BOCK, Berlin (DE)

(21) Appl. No.: 19/079,870

(22) Filed: Mar. 14, 2025

Related U.S. Application Data
(60) Provisional application No. 63/745,116, filed on Jan. 14, 2025.

(51) Int. Cl. G06F 40/40; G06F 40/30

(52) U.S. Cl. CPC G06F 40/40; G06F 40/30

(57) ABSTRACT

A blackboard data store contains records representing a plurality of AI agent operation results associated with the system (including an operation identifier). A decision support platform, coupled to the blackboard data store and being associated with at least one LLM, may receive a decision support request from a user associated with the system and determine a series of operations associated with the decision support request. A coordination agent may arrange for the series of operations to be performed by a plurality of AI agents, with operation results being recorded in the blackboard data store. Decision support information can then be presented to the user in response to the decision support request. According to some embodiments, the plurality of AI agents include a question planning and analysis agent, a research agent a decision option suggestion agent, a decision option evaluation agent, a critique agent, and/or a decision presentation agent.

### CROSS REFERENCE TO RELATED APPLICATIONS

The present application claims the benefit of U.S. Patent Application No. 63/745,116 entitled “ARTIFICIAL INTELLIGENCE MULTI-AGENT SYSTEM FOR DECISION SUPPORT” and filed Jan. 14, 2025. The entire content of that application is incorporated herein by reference.

### BACKGROUND

System-level decision-making can be difficult because decisions are complex, stakes are high, data is difficult to obtain or distributed across multiple data sources, knowledge is distributed across multiple people, there is little to no historic precedence, and decisions often need to be taken under enormous time pressure. In addition, behavioral psychology has shown that decisions are typically governed by a multitude of factors that prevent good decision-making: overconfidence bias, availability heuristic, sunk cost fallacy, anchoring heuristic, group think, and emotional reactions. All of these factors effectively hinder good decision-making, which should follow objective, data-driven reasoning. Moreover, poor decision making can result in significant corporate and/or economic damage.

While it is difficult to quantify the effects of bad decision-making, it is relatively common, and decisions that do not follow best practices can have substantial negative ramifications. However, it can be difficult, time consuming, and costly to efficiently propose and analyze decisions - especially when there is a substantial amount of system information and/or a large number of data sources to be considered. It would be desirable to provide decision support in a secure, automatic, and efficient manner.

### SUMMARY

According to some embodiments, methods and systems may include a blackboard data store that contains records representing a plurality of AI agent operation results associated with the system (including an operation identifier). A decision support platform, coupled to the blackboard data store and being associated with at least one LLM, may receive a decision support request from a user associated with the system and determine a series of operations associated with the decision support request. A coordination agent may arrange for the series of operations to be performed by a plurality of AI agents, with operation results being recorded in the blackboard data store. Decision support information can then be presented to the user in response to the decision support request. According to some embodiments, the plurality of AI agents include a question planning and analysis agent, a research agent a decision option suggestion agent, a decision option evaluation agent, a critique agent, and/or a decision presentation agent.

Some embodiments comprise: means for receiving, by a computer processor of a decision support platform associated with at least one LLM, a decision support request from a user associated with an system; means for determining, by a coordination agent, a series of operations associated with the decision support request; means for arranging, by the coordination agent, for the series of operations to be performed by a plurality of Artificial Intelligence (“AI”) agents, with operation results being recorded in a blackboard data store that contains electronic records that represent a plurality of AI agent operation results associated with an system, each record including an operation identifier; and means for presenting decision support information to the user in response to the decision support request.

Some technical advantages of some embodiments disclosed herein are improved systems and methods to provide decision support in a secure, automatic, and efficient manner.

### BRIEF DESCRIPTION OF THE DRAWINGS

FIG. 1 is a high-level system architecture in accordance with some embodiments.

FIG. 2 is a decision support method according to some embodiments.

FIG. 3 is a multi-agent method in accordance with some embodiments.

FIG. 4 is a communication architecture according to some embodiments.

FIG. 5 is a high-level architecture of a decision support system in accordance with some embodiments.

FIG. 6 is a coordination implementation according to some embodiments.

FIG. 7 is a termination method in accordance with some embodiments.

FIG. 8 is a coordination method according to some embodiments.

FIG. 9 is a question analysis and planning implementation in accordance with some embodiments.

FIG. 10 is a question analysis and planning method according to some embodiments.

FIG. 11 is an analysis method in accordance with some embodiments.

FIG. 12 is a planning method according to some embodiments.

FIG. 13 is a research implementation in accordance with some embodiments.

FIG. 14 is a research method according to some embodiments.

FIG. 15 is a decision option suggestion implementation in accordance with some embodiments.

FIG. 16 is a decision option suggestion method according to some embodiments.

FIG. 17 is a decision option evaluation implementation in accordance with some embodiments.

FIG. 18 is a decision option evaluation method according to some embodiments.

FIG. 19 is a critique implementation in accordance with some embodiments.

FIG. 20 is a critique rubric according to some embodiments.

FIG. 21 is a decision presentation implementation in accordance with some embodiments.

FIG. 22 is a decision presentation method according to some embodiments.

FIG. 23 is a detailed multi-implementation decision support system in accordance with some embodiments.

FIG. 24 is an apparatus or platform according to some embodiments.

FIG. 25 is a portion of a decision support database in accordance with some embodiments.

FIG. 26 is a portion of a scratchpad in accordance with some embodiments.

FIG. 27 is a portion of a blackboard in accordance with some embodiments.

FIG. 28 illustrates a tablet computer decision support display according to some embodiments.

FIG. 29 is an operator or administrator decision support display in accordance with some embodiments.

### DETAILED DESCRIPTION

In the following detailed description, numerous specific details are set forth in order to provide a thorough understanding of embodiments. However, it will be understood by those of ordinary skill in the art that the embodiments may be practiced without these specific details. In other instances, well-known methods, procedures, components and circuits have not been described in detail so as not to obscure the embodiments.

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers'specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

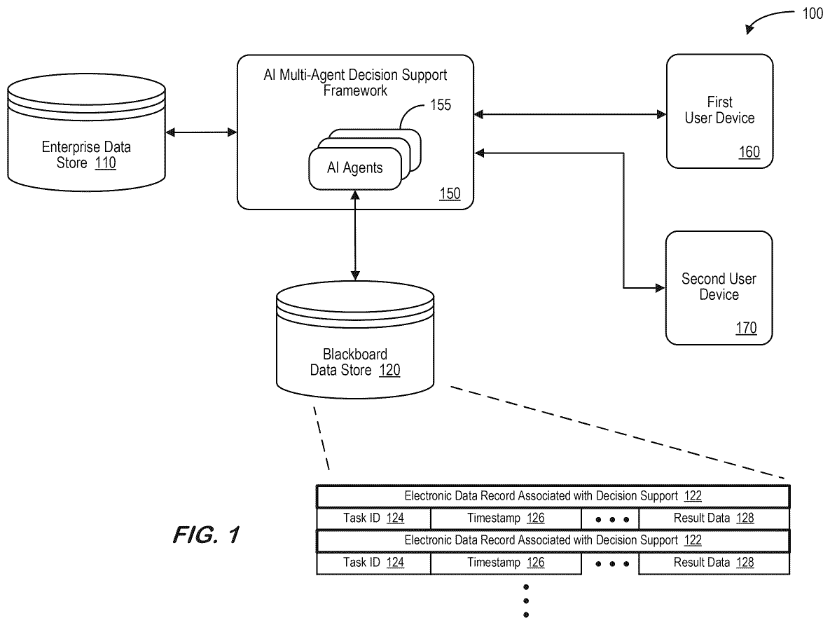

Embodiments described herein may provide a novel AI-agent based approach to support and automate large portions of corporate decision preparation and significantly enhance the quality of decisions that are implemented. FIG. 1 is a high-level block diagram of one example of a system 100 architecture according to some embodiments. In particular, a system data store 110 may contain structured and/or unstructured information, such as system goals, financial results, best practices, etc. A blackboard data store 120 may contain electronic data records associated with decision support 122. Each record might, for example, be associated with an operation identifier 124, a timestamp 126, result data 128, etc. The system 100 may include an AI multi-agent decision support framework 150 with AI agents 155 that can decision support capabilities via interactions with first and second user devices 160, 170.

As used herein, devices, including those associated with the system 100 and any other device described herein, may exchange information via any communication network which may be one or more of a Local Area Network (“LAN”), a Metropolitan Area Network (“MAN”), a Wide Area Network (“WAN”), a proprietary network, a Public Switched Telephone Network (“PSTN”), a Wireless Application Protocol (“WAP”) network, a Bluetooth network, a wireless LAN network, and/or an Internet Protocol (“IP”) network such as the Internet, an intranet, or an extranet. Note that any devices described herein may communicate via one or more such communication networks.

The AI agents 155 may store information into and/or retrieve information from various data stores (e.g., the system data store 110 and blackboard data store 120), which may be locally stored or reside remote from the AI agents 155. Although a single multi-agent decision support framework 150 is shown in FIG. 1, any number of such devices may be included. Moreover, various devices described herein might be combined according to embodiments of the present invention. For example, in some embodiments, the blackboard data store 120 and AI multi-agent decision support framework 150 might comprise a single apparatus. The system 100 functions may be performed by a constellation of networked apparatuses, such as in a distributed processing or cloud-based architecture. In some cases, the AI multi-agent decision support framework 150 may process information associated with a number of different systems, tenants, or customers.

The system 100 may be accessed via a remote device (e.g., a Personal Computer (“PC”), tablet, or smartphone) to view information about and/or manage operational information in accordance with any of the embodiments described herein. In some cases, an interactive Graphical User Interface (“GUI”) display may let an operator or administrator define and/or adjust certain parameters via a remote device (e.g., to specify how the elements connect with a system computing environment infrastructure) and/or provide or receive automatically generated recommendations, alerts, summaries, or results associated with the system 100.

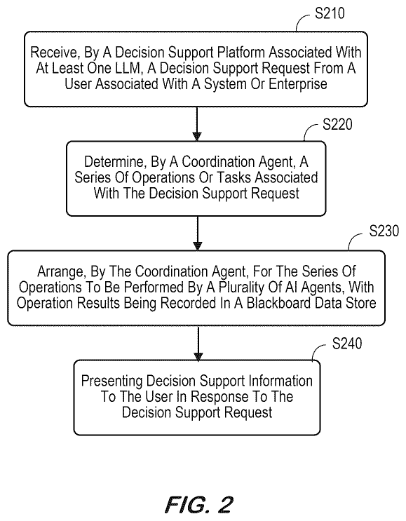

FIG. 2 is a decision support method that might be performed by some or all of the elements of the system 100 described with respect to FIG. 1. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

At S210, a computer processor of a decision support platform associated with at least one LLM receives a decision support request from a user associated with a system (e.g., an enterprise). At S220, a coordination agent determines a series of operations (e.g., tasks) associated with the decision support request. At S230, the coordination agent arranges for the series of operations to be performed by a plurality of AI agents, and operation results are recorded in a blackboard data store that contains electronic records that represent a plurality of AI agent operation results associated with the system, each record including an operation identifier. Finally, at S240, decision support information is presented to the user in response to the decision support request.

In this way, a multi-agent framework can help corporate decision-makers and staff put together well-founded, thoroughly justified, and data-driven decision foundations. The framework may automate many of the operations that are currently performed manually and execute them in an objective way following a structured methodology to implement industry and system best practices. This may increase the quality of system decisions and have a positive impact on resulting business outcomes.

As used herein, the term “decision” may refer to the act of selecting one out of multiple possible (decision) options in the face of a given goal (e.g., a desirable outcome). For example, if the goal is to travel to work given the decision options: on foot, by car, by bike, or by train, then the decision refers to choosing one of these options.

An “implied decision” or “decision need” is a decision for which a choice needs to be made but only a goal is given. In this case, the decision options might be generated from the set of all possible decision options capable of achieving the goal. Such a set of decision options is called “decision suggestion.” A decision suggestion is complete if it contains all available options. Since this is neither possible nor desirable in most cases, embodiments may utilize “incomplete decision suggestions” (typically very small) which represent a subset of all possible decision options.

As used herein, the phrase “decision evaluation” refers to the application of an evaluation function on the decision options with the aim to assess the quality of the decisions with respect to a desired outcome.

When generating incomplete decision suggestions, the decision options with the highest evaluations are part of the decision suggestion. In this case, the decision suggestion is representative (otherwise, it is non-representative) with respect to a given evaluation function. The decision suggestion should represent a good representation of all available decision options if none of the left-out options Do not evaluate better than the included options. Note that a decision suggestion can be representative even if many non-included decision options are almost as good as the included ones, or maybe even slightly better, in a more pragmatic interpretation of the definition that might be better suited for real-world scenario where it is difficult to assert provable guarantees over an often-infinite set of decision options.

A decision (suggestion) request is a user input, often in the form of a question or an instruction, that refers to a goal and either provides or implies a decision, with the aim of evaluating a representative set of decision options with respect to some evaluation function. For example, the question “how can margins be increased?” implies that a decision needs to be taken with the goal of improving margins. This decision is only implied since the available options are not given as part of the request. The request asks for a representative set of decision options (such as “reduce costs” or “raise prices”) with respect to an evaluation, which might assess how good these options compare at achieving the goal. For example, as measured by the obtained increase in margins, the effort required to put these options into action, and/or a combination of multiple measures. A “decision template” is a structured way of representing decision options. It may be provided by a user and contain multiple sections (each dedicated to a particular decision option or sub-sections for each of them).

An “AI agent” is a software system that uses AI to autonomously pursue a given goal. To achieve its goal, the agent may be configured to use a set of software tools. Common tools include access to internet search, symbolic reasoning, an ability to use certain Application Programming Interfaces (“APIs”), or code execution. AI agents may make use of LLMs but may differ from these models through a programmatic approach to break down goals into a sequence of smaller steps (and executing these steps until the goal is achieved).

Multi-agent systems let multiple agents collaborate towards achieving a given goal. The benefit of a multi-agent system is that each agent can be more specialized to fulfill a given operation. This can increase the quality of the outcomes while keeping complexity low. For example, there may be one agent whose job is to coordinate and synthesize the work of the other agents in a multi-agent system. Such a coordination agent may differ from traditional AI agents in that it delegates work to other agents rather than more traditional software tools.

An AI multi-agent system may be designed to address a complex problem involving decision preparation and evaluation. According to some embodiments, an AI multi-agent system lets a user ask open-ended questions that require a possibly complex business decision and uses this input to autonomously generate and evaluate relevant decision options. An example question might be “how can margins be increased?” The AI multi-agent system will then analyze this question and suggest multiple decision options, such as “expand market reach in emerging markets like southeast Asia by developing localized solutions” or “leverage strategic partnerships with local tech companies and government agencies to drive co-innovation and ecosystem growth.”

An AI multi-agent system might not solve the decision design and evaluation operation in one pass, however, since this would require AI multi-agent system to have perfect knowledge of system and user context. Instead, the AI multi-agent system may execute multiple rounds. During each round, the agent incorporates all of its knowledge and context in an attempt to prepare the best possible decision planning and evaluation using this knowledge. The results are then presented to the user, who may accept the output or guide the AI multi-agent system towards a better decision foundation by modifying decision suggestions, critiquing the agent's work in total, and/or making suggestions for improvement. As such, the collaboration between the AI multi-agent system and users is similar to that between two people collaborating towards iteratively creating a decision foundation. In this way, the AI multi-agent system may act as an assistant for decision modelling and data retrieval.

To accomplish its goal, the AI multi-agent system has access to various company data sources, such as financial, sales or Human Resources (“HR”) data, and can be configured to approach the operation in a particular way by an administrator or business user. Users can optionally upload additional information, such as strategic documents, market detailed reasonings or industry reports. The AI multi-agent system may leverage a multi-agent system approach, since it requires a complex interplay between multiple complex operations, as described herein. Each of these operations may be delegated to a dedicated, specialized agent with clear responsibilities, a well-defined interface, and interaction rules with other agents that follow its own agent logic. The AI multi-agent system may leverage one master agent to coordinate the work of other agents and delegate the work to relevant agents in a targeted and dynamic way.

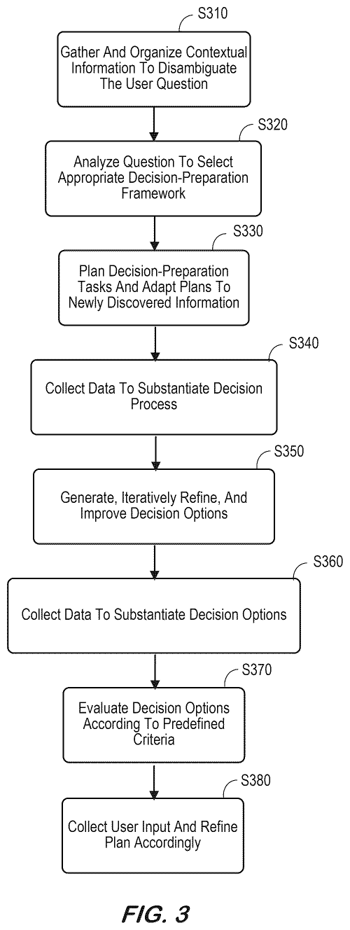

FIG. 3 is a multi-agent method in accordance with some embodiments. At S310, the system may gather and organize necessary contextual information needed to disambiguate the user ask. This might be necessary, for example, when a user asks ambiguous questions. At S320, the question is analyzed to select an appropriate decision-preparation framework (e.g., including the order in which operations are called, operation descriptions and desired outcomes, etc.), and decision-preparation operations are planned and adapted plans to newly discovered information at S330. At S340, the system generates and iteratively refines/improves the decision options. At S350, the data to substantiate the decision options is collected, and the decision options are evaluated at S360 according to predefined criteria. At S370, the results are presented, and user input is collected (with the plan may being refined accordingly) at S380.

Initially, an agent may perform this sequence of actions in the given order, but each of the steps might be iterated multiple times to refine the results. As in real life, however, decision options and evaluations may need to be developed in an iterative, incremental way, since newly defined decision options can give rise to questions about which data needs to be analyzed. Moreover, the analyzed data might give rise to the need to refine or discard decision options. For example, during decision-option generation there might be a suggestion to re-negotiate prices with suppliers, but a look into the data and available industry benchmarks might show that prices are already at the low end of the spectrum (which could lead the agent to discard this decision option). This may require additional communication and/or non-linear coordination between the agents.

The high-level coordination and delegation of the operations may be performed by a coordination agent. Other operations may be delegated to specialized agents for the respective functions. In this way, each agent can be optimized for the respective operation, and embodiments may implement flexible agent coordination patterns. Each agent may use an internal “scratchpad” and a “blackboard” shared between agents might be used to jointly add data, thoughts, and intermediate results. Some of the agents may also access a decision template, which may be gradually completed during the process. Note that each agent may have clear responsibilities and authorizations to contribute to the decision template (e.g., only a decision-option generation agent edit decision, only an evaluation agent can edit the evaluation and recommendation sections of the decision template, etc.).

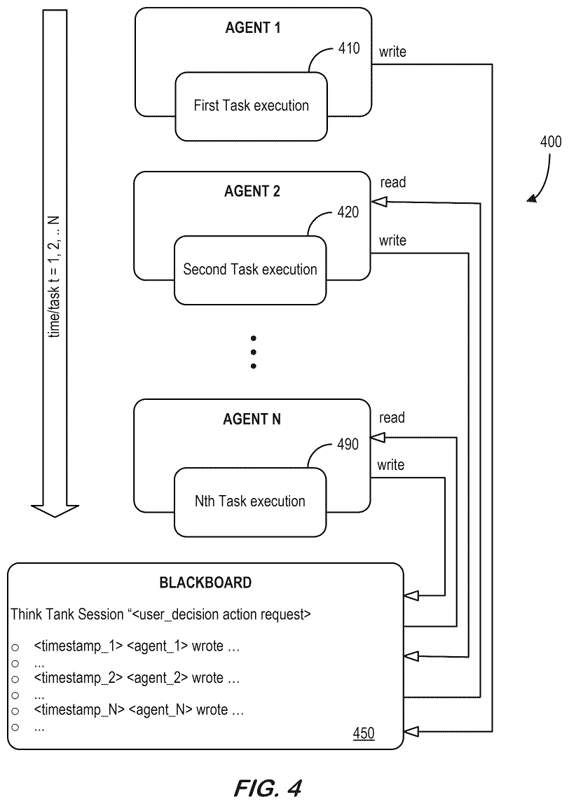

To allow for the coordination between the agents, each agent may provide a summary of their work to the coordination agent along with possible recommendations about next steps. For example, an agent responsible for analyzing final results could conclude that another option needs to be generated in order to reflect a greater degree of diversity of decision options or conclude that the decision evaluation criteria have not been applied consistently. In the first case, the coordination agent may conclude that it needs to invoke the agent responsible for decision-option generation. In the latter, it may conclude that it needs to invoke the decision evaluation agent. In both cases, it may share the respective feedback as part of input with the respective agents. FIG. 4 is a communication architecture 400 according to some embodiments. In particular, agent 1 performs a first operation 410 and writes a result to a blackboard 450 (e.g., including a timestamp, an agent identifier, etc.) Agent 2 reads that result from the blackboard 450, performs a second operation 420, and writes its own result to the blackboard 450. This continues until an Nth operation 490 is executed.

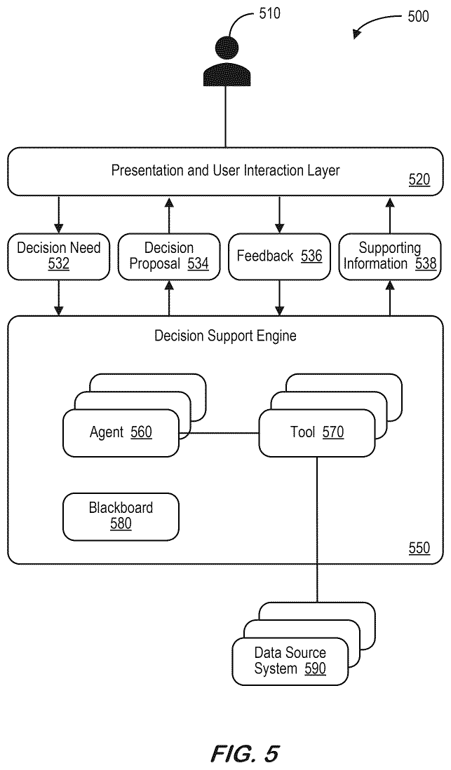

FIG. 5 is a high-level architecture 500 of a decision support system in accordance with some embodiments. In particular, a user 510 interacts with a decision support engine 550 via a presentation and user interaction layer 520 (e.g., to exchange information about a decision need 532, a decision suggestion 534, feedback 536, supporting information 538, etc.). The decision support engine 550 may use agents 560, tools 570, a blackboard 580 (containing the agents 560 collective working memory), and data source systems 590 to provide decision support. The data source systems 590 might include, for example, a set of documents that provide context about an system, strategy, business information, content from relevant knowledge domains (e.g., finance, HR, or procurement), and other relevant sources of knowledge that help the agents 560 contextualize the work of the system and user. These documents might be accessed through Retrieval-Augmented Generation (RAG″), GraphRAG, and/or knowledge graph-based approaches. In some embodiments, the data source systems 590 includes a set of databases that contain relevant structured, tabular information that the agents 560 may need to consider. Such databases may be accessible through an analytical model and include information about system finances, suppliers, employees, etc.

When each of the individual agent 560 concludes its work (without any further requests towards other agents), a single round of the AI multi-agent system is finished and the results are presented to the user 510. Note that this does not imply that the decision-planning operation is complete. The user 510 may critique the AI multi-agent system and ask it to modify the content that was prepared at multiple levels (e.g., including the available options, the data supporting the options, the way the options are evaluated, etc.). In some embodiments, the AI multi-agent system displays intermediate results to the user 510 by streaming the content (so the user 510 can always see how the decision suggestion is developing in real time). This may include the outputs of each specialized agent 560, such as the gathered relevant context information, the plan to come to a decision suggestion, and/or a draft of the decision options. The user 510 can then decide to give feedback during the agent's work, which will be integrated into the system plan in real time. In some embodiments, the system summarizes the current work for the user 510 and shares the outcome of agents 560 as they are in real time. During each round (in real time), or after each round of the AI multi-agent system's work, the user 510 can provide detailed feedback 536 and instructions for improving the agents 560 work.

The AI multi-agent system may support multiple features that help overcome common issues in decision-making (including harmful biases and heuristics) that typically lead to poor decision-making. For example, A decision option generation agent may make sure that there is a diversity of perspectives and decision options that are representative of all relevant available options. A decision evaluation agent may make sure that options are evaluated in an objective way. A question analysis and planning agent may log all user requests related to the decision, effectively creating an audit trail of how the decision was shaped. For example, the system may document if relevant decision options were dropped without good reason.

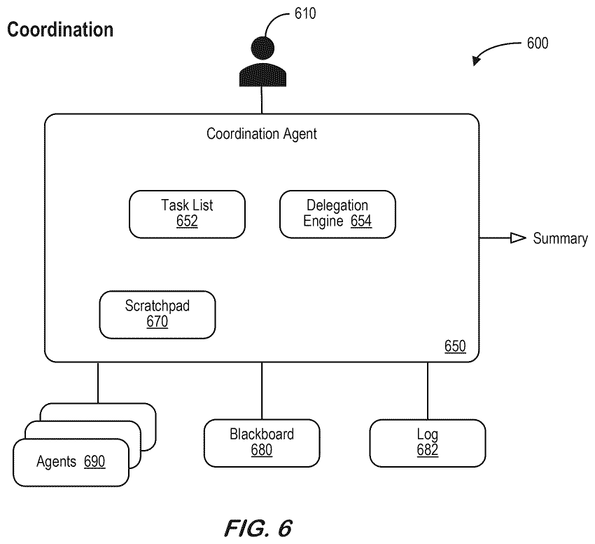

FIG. 6 is a coordination implementation 600 according to some embodiments. In particular, a coordination agent 650 communicates with a user 610, a shared blackboard 680, and an audit log 682, and other AI agents 690 to output a decision result or summary. The coordination agent 650 may use an operation list 652, a delegation engine 654, and/or a local scratchpad 670 to perform this function.

The operation of the coordination agent 650 is to orchestrate the work of the other agents 690. It may receive a user question and feedback as inputs and delegate the work to the other agents 690 accordingly. Initially, all the coordination agent 650 does is to forward the user question or feedback to a question analysis and planning agent, which will then do its work and revert with a plan of how to address the decision planning operation and how to involve the other agents 690. The coordination agent 650 puts these operations into the operation list 652 and then delegates the work to individual agents 690 via the delegation engine 654. After delegating the work to an agent 690, the agent 690 does its job and submits a summarization of the result as well as recommendations for next steps. For example, a decision option agent might generate some decisions but ask for more context from the user. The coordination agent 650 then analyzes the feedback and decides what to do next based on the next action recommendations from the agent and the next operation in the list 652. The coordination agent 650 might for example: follow the recommendations of the agent and trigger the next step as suggested by the agent (such as requesting user feedback before proceeding); pick up the next operation in the operation list 652; or terminate its work for the given round and give control back to the user. As such, the coordination agent 650 might not implement any complex logic per se, but instead makes sure that all work gets distributed correctly between the agents 690 and the user 610.

The decoupling between a planning agent and the coordination agent 650 may allow for an easier adaptation and configuration of the planning agent while maintaining a generic and re-usable framework for the multi-agent coordination (easily adding and modifying agents 690 as necessary). Asking each agent 690 to suggest possible next actions helps keep the complexity of the planning agent low. With this design, the planning agent only handles generic planning operations while the individual agents 690 encapsulate all of the relevant knowledge to suggest additional work based on their work domain. This prevents an unnecessary coupling of the agent-specific domain knowledge with the generic planning agent's logic. This keeps the design modular, extensible, and keeps the complexity of the individual agents in check (making this architecture highly scalable).

To accomplish its goal, the coordination agent 650 may need to balance the following criteria: finishing in the shortest possible appropriate time (where more complex and more consequential decisions are allowed more time); answering the user's decision request by maximizing the decision evaluation function; implementing all agent-provided next action recommendations; finishing all of the operations in its operation list 652.

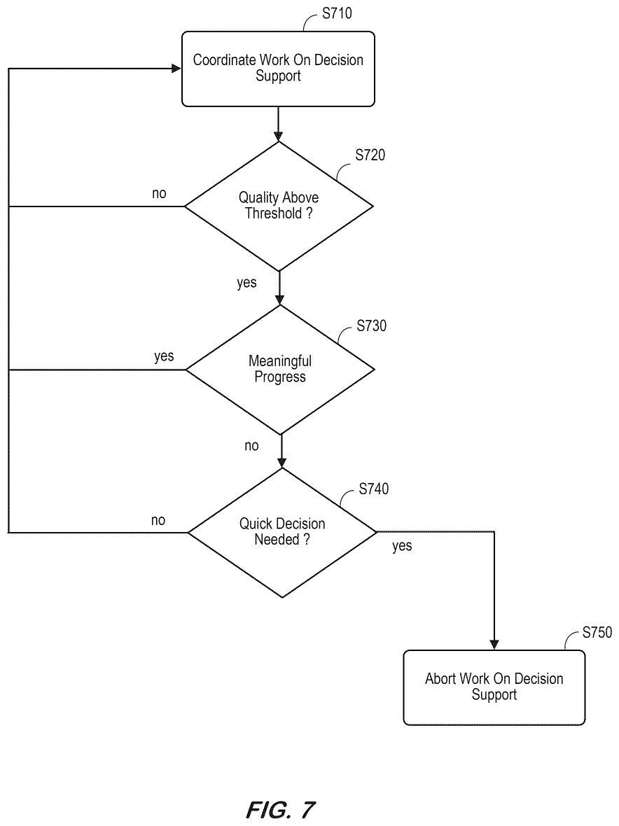

Another function of the coordination agent 650 650 may be the termination of decision support. For example, FIG. 7 is a termination method in accordance with some embodiments. At S710, it coordinates work on decision support and if the quality of the decision suggestion is above a given threshold at S720 (e.g., as assessed by a critique agent), the coordination continues at S710. If quality of the decision suggestion is below the threshold, but the AI multi-agent system has not been making meaningful progress at S730 addressing the decision suggestion's shortcomings, the agent may need additional user context. At S740, if the nature of the decision and the interaction with the user suggests that the user needs a quick presentation of the options (e.g., to get a quick first sense of how the decision is emerging and give feedback early on during the process), the decision support option may be aborted S750.

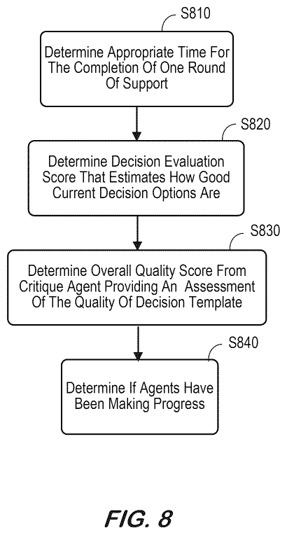

FIG. 8 is a coordination method according to some embodiments. At S810, the system determines an appropriate time for the completion of one round for the request from a question analysis and planning agent. The time might range from a few seconds for quick ad-hoc requests or interactive decision planning sessions to minutes or hours for complex hands-off decision planning. A decision evaluation score from the evaluation agent that estimates how good the decision options (e.g., on a scale from 0 to 100) is determined at S820. At S830, an overall quality score from a critique agent is determined that provides an overall assessment of the quality of the entire decision template. Note that this quality score may be generally independent from the decision evaluation score (e.g., if all decision options are good with respect to the evaluation function but better options or highly relevant alternative options have not been included in the decision suggestion). An analysis of the scratchpad that can give the agent an idea of whether the other agents have been making progress at S840 or are instead going around in circles (e.g., because similar content is getting repeated over and over).

If the appropriate time is exceeded, the agent may prioritize finishing the minimum set of necessary steps to get back to the user (e.g., trying to provide its intermediate output to the user as quickly as possible, regardless of the evaluation or quality score). If these scores do not exist and there was not enough time to complete the request, the agent asks the user for the approval to spend more time on the decision planning. If the scores exist, the agent summarizes the scores and adjusts answers accordingly (and asks for additional user input and guidance such as when evaluation or quality scores are low).

The coordination agent 650 has access to a dedicated scratchpad that all agents use for collecting output to be shared with the user outside of the decision template. This content can be a summary of their work, further considerations for the user or an explanation of certain assumptions that went into the agent's work. Before giving control back to the user, the coordination agent 650 summarizes and organizes this output for the user and shares it with the user along with the decision template. According to some embodiments, the coordination agent 650 logs all of the interactions to generate an audit trail of the decision planning process.

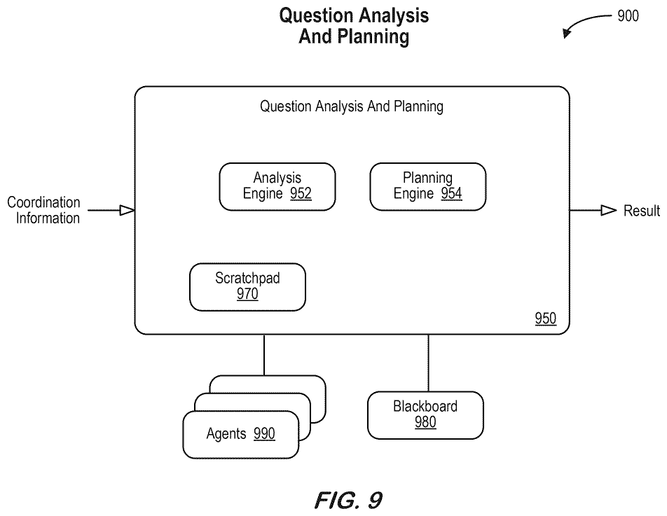

FIG. 9 is a question analysis and planning implementation 900 according to some embodiments. In particular, a question analysis and planning agent 950 communicates with a shared blackboard 980 and other AI agents 990 to output a decision result. The question analysis and planning agent 950 may use an analysis engine 952, a planning engine 954, and/or a local scratchpad 970 to perform this function.

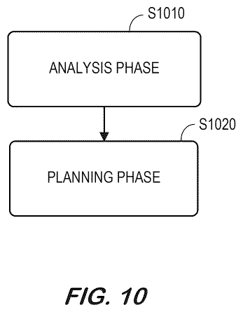

The main operation of the question analysis and planning agent 950 is to make sense of the user's input and create a plan for how each of the other agents 990 needs to be involved to best respond to the user's question. As the name suggests, the agent 950 works in two phases. FIG. 10 is a question analysis and planning method according to some embodiments. In an analysis phase at S1010, the agent 950 essentially tries to disambiguate the user's question and identify possible self-evident context gaps that need to be clarified. In a planning phase at S1020, the agent creates a plan.

During the agent's analysis phase S1010, a series of questions are asked about the user request to determine key elements of the request, including a goal, possible information about existing decision options, which entities are mentioned explicitly, which entities are mentioned implicitly, etc. The agent 950 then collects relevant information about these entities from the knowledge base. This may include searching existing embeddings and knowledge graphs to retrieve relevant business context, relevant information about the entities, a clear interpretation about the goal, and any other key elements that were identified and may need to be better specified. The agent 950 then uses all of this context to generate a more detailed request that includes all of the identified relevant information. The agent 950 then if there are any remaining ambiguities that need to be clarified by the user (e.g., if the user explicitly mentioned an organizational team but it is unclear if they were referring to the team that the user manages or another team. The agent 950 will then assess each of these items and respond in one of two ways: (1) if the agent 950 is relatively confident about what the user wants, it can disambiguate the request accordingly and add an assumption to the output notepad along with its confidence (letting this assumption be later transparently shared with the user); or (2) any remaining ambiguities will be noted in the agent's proprietary scratchpad 970 in the form of clarifying questions that need to be answered before proceeding.

It is important to note that this agent only performs simple queries to disambiguate the query and enhance it semantically. The agent is not equipped to handle more complex analytical queries.

In a second step, the agent brainstorms on which data may need to be considered for a decision as specified through the detailed decision request. It shares this information in the form of specific operations or open-ended questions on the scratchpad to be picked up by the research agent.

Lastly, using the resulting detailed decision request, the agent then classifies the decision request, which allows it to create an action plan that is tailored to the user's context.

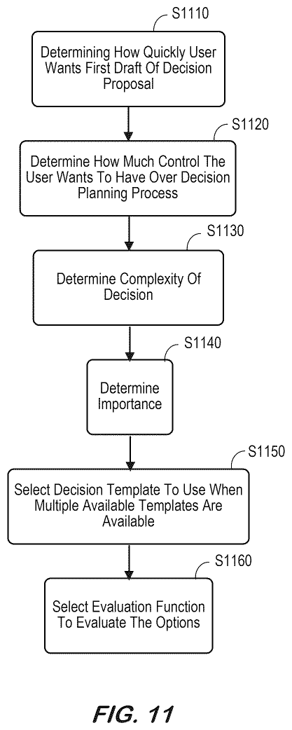

FIG. 11 is an analysis method in accordance with some embodiments. At S1110, the system may determine how quickly the user wants or needs a first draft of the decision suggestion. At S1120, it is determined how much control the user wants to have over the decision planning process vs. how autonomously this should be done (e.g., by analyzing past user behavior, or by allowing the user to toggle between fully autonomous, user as co-pilot, and agent-assisted planning modes). The complexity of the decision is determined at S1130 (e.g., simple, well-understood action-impact relationships vs. highly interdependent, poorly understood impact of given actions with many possible side effects). At S1140, various factors associated with determining the potential impact of the decision or how much is at stake. For example, might have a minor, medium, or large monetary impact or individual, career, life, team, organizational risks, etc.). The system selects which decision template should be used at S1150 when there are multiple templates available (e.g., one per domain or use case, such as Strengths, Weaknesses, Opportunities, and Threats (“SWOT”), strategic planning and management, advantages vs. disadvantages, a Porter's Five Forces framework for corporate strategy, etc.). At S1160, the evaluation function that will be used to evaluate the options is selected.

During subsequent analysis phases (e.g., after the agent has already done a lot of the fundamental analysis work), the agent focuses primarily on the delta between the previous work and the user feedback or the feedback from the other agents. Depending on this feedback, the agent may decide to either redo the complete analysis or to reuse and simply augment previous work.

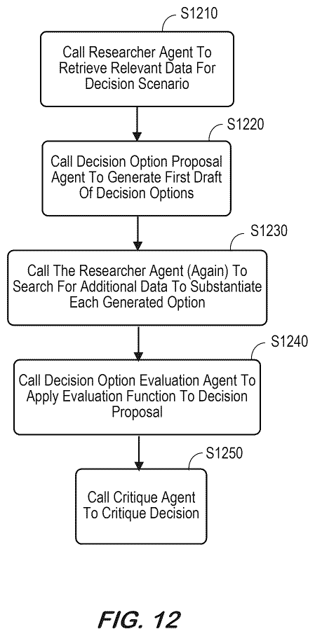

FIG. 12 is a planning method according to some embodiments.

If, during the analysis phase, a significant number of clarifying questions have remained open, the planning agent 950 only plans for one action, which is to share current assumption and all clarifying question with the user so the user can provide additional context.

Otherwise, the agent now can work with a detailed and fully disambiguated decision request. The agent then uses all of the information obtained during the analysis phase to put together a plan that involves the other agents. This includes selecting the template and evaluation function accordingly. The agent then uses its reasoning capabilities for the plan but is instructed to follow the sequence of steps provided below as much as possible:
S1210, the agent 950 calls a research agent to retrieve relevant data for the decision scenario and add it to the scratchpad 970 (e.g., “retrieve current company revenue and margins” if these were referred to in the decision request). At S1220, the agent 950 call a decision option suggestion agent to generate a first draft of decision options using the data from the research agent and the selected decision template. At S1230, the agent 950 may call the research agent (again) to search for additional data substantiating each of the generated options. At S1240, the system calls a decision option evaluation agent to apply the evaluation function to the given decision suggestion. The agent 950 can then call a critique agent to critique the decision.
such an approach may help ensure that the agent 950 follows a well-defined methodology while having the flexibility to change the plan depending on the decision request (e.g., if the user only needs a quick first draft, the planning agent 950 might decide to only use the decision option suggestion agent to generate a quick decision draft and immediately give control back to the user). The agent 950 might also specify how much effort other agents individually should put into the operation at hand (e.g., low, medium, or high) which lets it make tradeoffs between the available time budget and the quality of the work of each agent. Depending on how much is at stake, the agent 950 could down-regulate or up-regulate each of the steps (e.g., if the agent 950 operates in agent-assisted mode, a critique agent might not be as relevant as in fully autonomous mode).

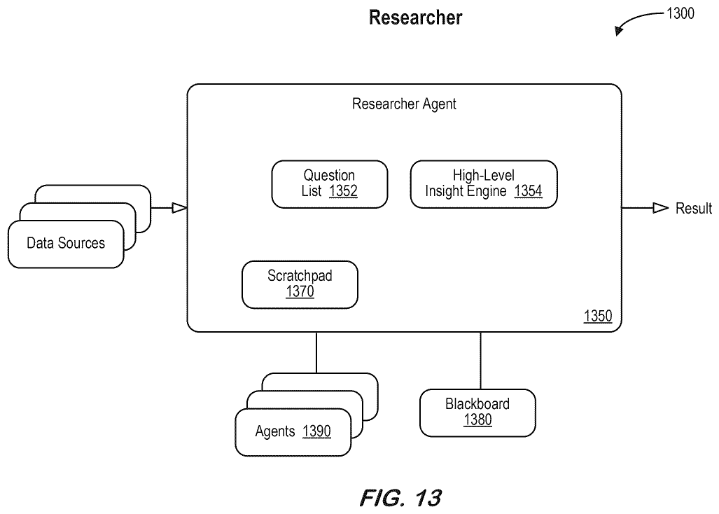

FIG. 13 is a research implementation 1300 in accordance with some embodiments. In particular, a research agent 1350 communicates with data sources, a shared blackboard 1380, and other AI agents 1390 to output a decision result. The research agent 1350 may use a question list 1352, a high-level detailed reasoning engine 1354, and/or a local scratchpad 1370 to perform this function. The main operation of the research agent 1350 is to analyze relevant data for detailed reasonings that need to be considered to obtain a good decision in the context of the proposed decision options. The research agent 1350 can be configured to use a wide variety of data sources during setup by an administrator.

The research agent 1350 inputs may include the user request and the decision options that a decision option suggestion agent has assembled, along with all of the notes that were shared by the other agents 1390. The information shared may include open questions concerning data or detailed reasonings, specific research-related operations, and/or analytical detailed reasonings requested by other agents 1390. Note that a decision option suggestion agent may not have started its work and there may not be any decision options available, in which case the research agent 1350 focuses on more generic research based on the decision request and the research operations and questions shared by the other agents 1390 (if any).

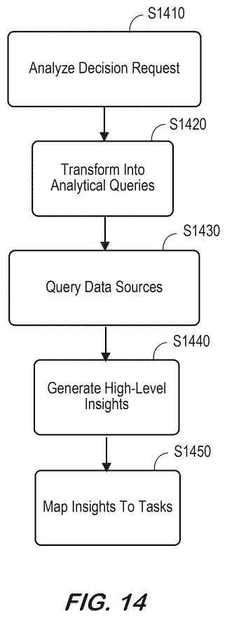

FIG. 14 is a research method according to some embodiments. At S1410, the research agent 1350 begins by analyzing the decision request along with the information provided on the scratchpad and compiling a list of analytical questions to be answered. The agent is configured 1350 with access to a variety of knowledge base data sources. Contrary to the question analysis and planning agent, however, the focus of the research agent 1350 is on data-driven detailed reasonings about the decision request, most of which the agent 1350 will obtain from the structured data included in its knowledge base and the additional data provided by the user along with the decision request.

At S1420, the agent 1350 takes the questions it has formulated and transforms them into a set of analytical queries that can be mapped onto the existing data sources. It accomplishes this using its LLM reasoning and planning capabilities, utilizing semantic information about the type of data stored in each data source, as well as instructions about how they should be used. At S1430, the agent 1350 then queries the data sources for relevant information and assembles this information in its internal working memory. This working memory may consist of the scratchpad 1370 for remembering text-based detailed reasonings and a structured database in which structured information in tabular form can be stored for further processing.

At S1440, the agent 1350 can then utilize in-context code generation to generate higher-level detailed reasonings and summarize all obtained detailed reasonings. In some embodiments, the agent 1350 retains an explanation of how detailed reasonings were obtained along with the used data sources that can be shared with the user as part of the decision template. As a final step, at S1450 the agent 1350 maps the obtained detailed reasonings to the analytical operations and questions shared through the blackboard 1380 so that other agents 1390 can use the information in subsequent steps. The agent 1350 also notifies the coordination agent that it has obtained new information for the respective agents and that they may need to be activated to process this information. All detailed reasonings not directly related to a particular analytical operation or question are shared with all agents 1390. This information may then be used by the decision suggestion agent to analyze and enhance the decision-making suggestion with the obtained detailed reasonings.

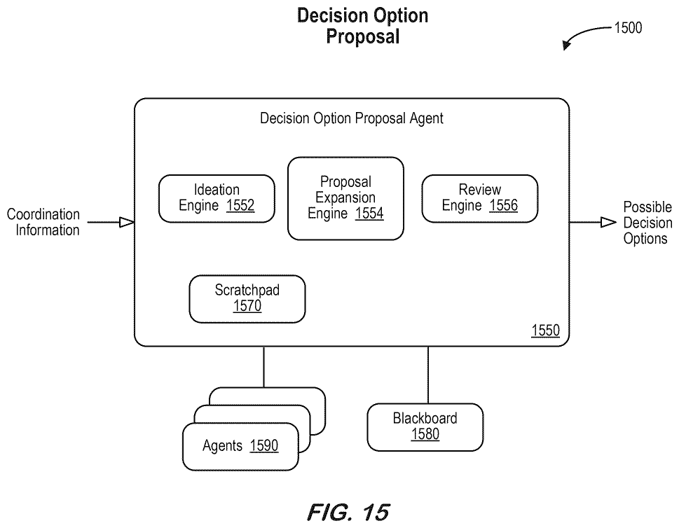

FIG. 15 is a decision option suggestion implementation 1500 in accordance with some embodiments. In particular, a decision option suggestion agent 1550 communicates with a shared blackboard 1780 and other AI agents 1590 to output possible decision options. The decision option suggestion agent 1550 may use an ideation engine 1552, a suggestion expansion engine 1554, a analyze engine 1556, and/or a local scratchpad 1570 to perform this function. The main operation of the decision option suggestion agent 1550 is to generate possible decision options given as input the detailed user decision request that has been previously enhanced by the question analysis and planning agent. The agent 1550 works in three phases: (1) a high-level planning phase (during which the agent 1550 creates initial decision suggestions at a high level to ensure that there is a high degree of consistency among the decision suggestions; (2) a refinement phase (where the agent 1550 then refines each suggestion with additional information and consideration-either in parallel through a single prompt or by parallelization with multiple calls being sent to a LLM in parallel); and (3) a analyze phase where the agent 1550 looks at the combined set of suggestions and enhances the total summary of the content to create an additional layer of consistency on top of the individual suggestions).

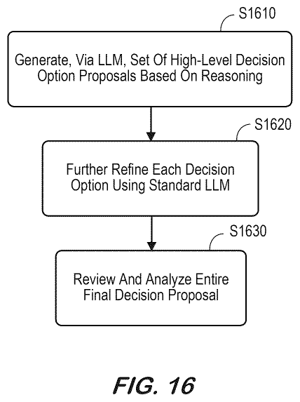

FIG. 16 is a decision option suggestion method according to some embodiments. At S1610, the agent 1550 uses a LLM optimized for reasoning to generate a first set of high-level decision option suggestions based on careful reasoning. The agent 1550 is given the detailed decision request as an input along with access to the knowledge base. As a first step, the agent 1550 analyzes the knowledge base and the scratchpad 1570 for any contextual information that might be relevant for generating the decision options. This is done by asking the model to analyze existing information and to clarify which additional information might be needed to make a good decision option suggestion. This information is then retrieved and summarized from the knowledge base and the scratchpad 1570. Equipped with that information, the reasoning model creates high level summaries of the decision options. In doing so, the model may be prompted to consider that the suggestion should be highly relevant to the decision request and tailored to the company using an AI multi-agent system rather than a generic suggestion (taking into account relevant company data and considerations). The decision suggestion should be representative and diversified in the sense that all relevant good decision options are included in the suggestion and that the suggestion should not be biased towards one particular, narrow set of options. It should not be possible to come up with a significantly different alternative decision option that is at least as good as or better than the represented options. In addition, the decision suggestion should be aligned with industry best practices. This can be achieved by either prompting the model to outline these industry best-practices using a chain-of-thought prompting technique or by including industry best practice content as part of the configuration or user request. The AI multi-agent system may have access to a representative set of industry best-practice content (e.g., from a database of publications that are made available via a RAG-based service). Moreover, the suggestion should also consider all relevant aspects of a decision and include all relevant perspectives, including financial and tax-related aspects, compliance-related aspects, people aspects, reputational aspects, etc. This may be accomplished by prompting the model to provide input from the perspective of multiple personae, including a Chief Executive Officer (“CEO”), Chief Financial Officer (“CFO”), Chief Operations Officer (“COO”), Chief Human Resources Officer (“CHRO”) and Chief Information Officer (“CIO”), among others. The high-level planning phase is only performed at the beginning of a decision option planning operations or if the user or agent feedback from the other agents 1590 suggest that the decision options need a major revision. In other cases, the agent 1550 immediately starts with the next phase.

At S1620, the agent 1550 further refines each of the decision options one-by-one using a standard LLM that does not need to be optimized for reasoning. This can be done by several parallel API calls to the LLM to a to save execution time, or it can be done using one large prompt processing all of decision options in one API call to save both time and cost at the expense of detail quality. To obtain the more detailed decision suggestions, the agent 1550 takes the high-level decision suggestions provided by the reasoning model and then expands on the provided high-level suggestions using its built-in knowledge and its knowledge base. The agent 1550 starts by asking which information might be relevant to substantiate the individual decision options and retrieving this data from the knowledge base, e.g. via a RAG-based approach and then it uses this information to provide a more detailed description of this decision option along with a description of possible expected implications. After the decision option has been refined in this way, the agent 1550 analyzes the decision options to determine which data may need to be used to further enhance it and make it more reliant on data. This concerns both questions related to existing Key Performance Indicators (“KPIs”) relevant for the decisions as well as possible predictions about implications. This is also where the agent 1550 can ask for predictive capabilities and Monte-Carlo simulation to quantify the decision options. The agent 1550 will then note down these analytical operations or open questions in the scratchpad 1570 for the research agent.

After all of the options have been refined in this way, at S1620 the agent 1550 analyzes the final decision suggestion in its entirety and analyses if it needs to be improved further before handing the work off to the next agent. The key focus during this phase is on consistency and plausibility of provided options and the provided data. Any additional analytical needs will be shared with the research agent through the blackboard 1580.

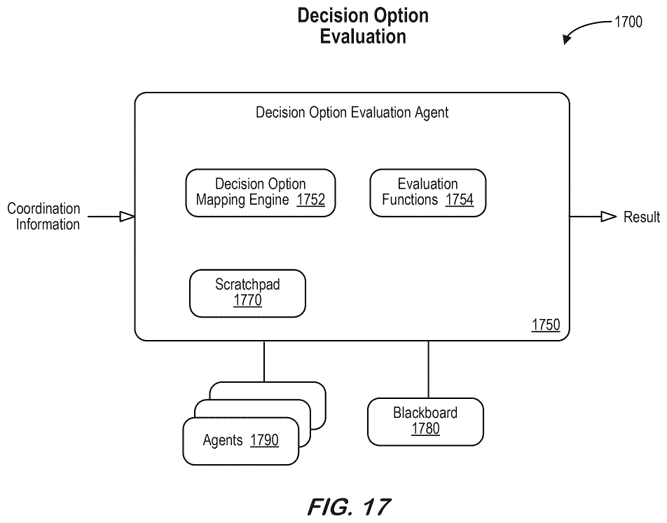

FIG. 17 is a decision option evaluation implementation 1700 in accordance with some embodiments. In particular, a decision option evaluation agent 1750 communicates with a shared blackboard 1780 and other AI agents 1790 to output a decision result. The decision option evaluation agent 1750 may use a decision option mapping engine 1752, evaluation functions 1754, and/or a local scratchpad 1770 to perform this function.

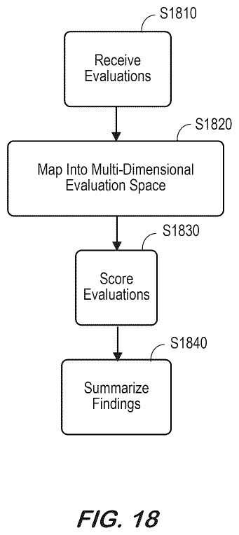

FIG. 18 is a decision option evaluation method according to some embodiments. The option evaluation agent's main responsibility is evaluating the decision options received from other agents 1790 at S1810 using the evaluation functions 1754 that are either built into its capabilities directly, or that the user provides as part of the configuration (or even as part of the decision request).

An evaluation function 1754 at S1820 maps each decision option into a possibly multi-dimensional evaluation space that lets decision options be compared along multiple dimensions. In its simplest form, the evaluation function 1754 could be represented in the form of a single business KPI, such as total cost reduction. This would let the decision-maker pick the decision options leading to the highest cost reduction. This KPI could already be part of the decision option (e.g., since the decision option suggestion agent determined that total cost reduction, being the evaluation function, should be included in the decision option template). However, in some cases a user may need to evaluate multiple KPIs associated with each decision option (e.g., if the price to pay for a high-cost reduction is letting a big portion of the workforce go, then this might have a negative impact on people, culture, and business continuity). Therefore, most evaluation functions 1754 seek to balance multiple KPIs and represents all of these KPIs to the user, letting the user choose the best option among a set of pareto-optimal decision options. However, it might not be possible to quantify the quality function and the user would prefer to evaluate decision options in a more qualitative way. The decision option evaluation agent 1750 supports this by allowing decision options to be evaluated against a given rubric. Such a rubric is the most generic way of representing decision evaluation functions for the AI multi-agent system and is defined by a matrix containing an arbitrary number of decision evaluation criteria, both quantitative and qualitative, along with a description of a scoring system for each of the criteria on a unified scale (e.g., ranging from 1 to 3, 1 to 5, or 1 to 10). These scores can then be used individually or by combining all scores into a total score to compare decision options at S1840. The AI multi-agent system may have built-in decision evaluation functions 1754 for common business scenarios across multiple lines of business, including evaluation functions 1754 for finance, HR, procurement and supply chain management. In addition, the AI multi-agent system may provide an interface where users can design new evaluation functions 1754 by describing which KPIs should be used and how they should be evaluated. The decision option evaluation agent 1750 then interprets these evaluation function descriptions and applies them to the given decision options in an objective way. By using standardized rubrics for recurring decisions, customers can thus evaluate all decisions consistently in a fair, compliant, objective, and even auditable way. After the agent 1750 has evaluated all of the decision options, it will also analyze and summarize the findings at S1840 and recommend the best decision options.

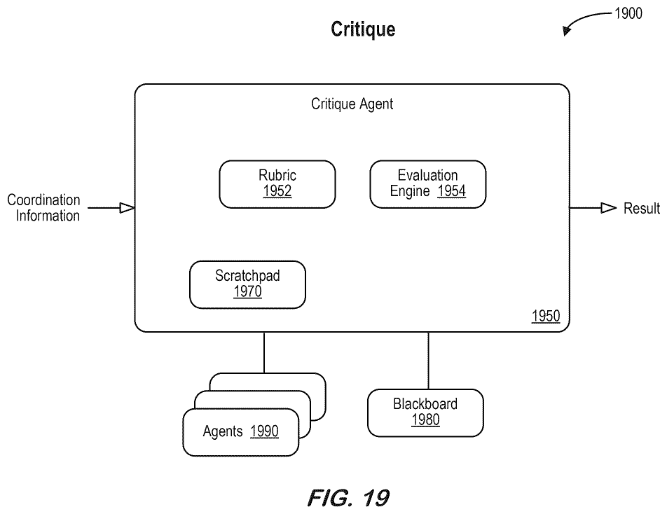

FIG. 19 is a critique implementation 1900 in accordance with some embodiments. In particular, a critique agent 1950 communicates with a shared blackboard 1980 and other AI agents 1990 to output a decision result. The critique agent 1950 may use a rubric 1952, an evaluation engine 1954, and/or a local scratchpad 1970 to perform this function. After the other agents 1990 have completed their work, the critique agent 1950 analyzes and critiques the results. While the individual agents 1990 may have already analyzed their work and tried to optimize the outputs of their respective responsibilities, the job of the critique agent 1950 is to analyze the overall results vis-à-vis the user's decision request and the company's decision-making criteria.

The AI multi-agent system may have built-in decision quality criteria, such as the suggestion should be highly relevant to the decision request and tailored to the system using the AI multi-agent system rather than a generic suggestion (taking into account relevant company data and considerations). The decision suggestion should be representative and diversified in the sense that all relevant good decision options are included in the suggestion and\that the suggestion should not be biased towards one particular, narrow set of options. Moreover, the decision suggestion should be aligned with industry best practices and should consider all relevant aspects of a decision and include all relevant perspectives, including financial and tax-related aspects, compliance-related aspects, people aspects, reputational aspects, etc. To achieve these goals, the critique agent 1950 may use a dedicated rubric.

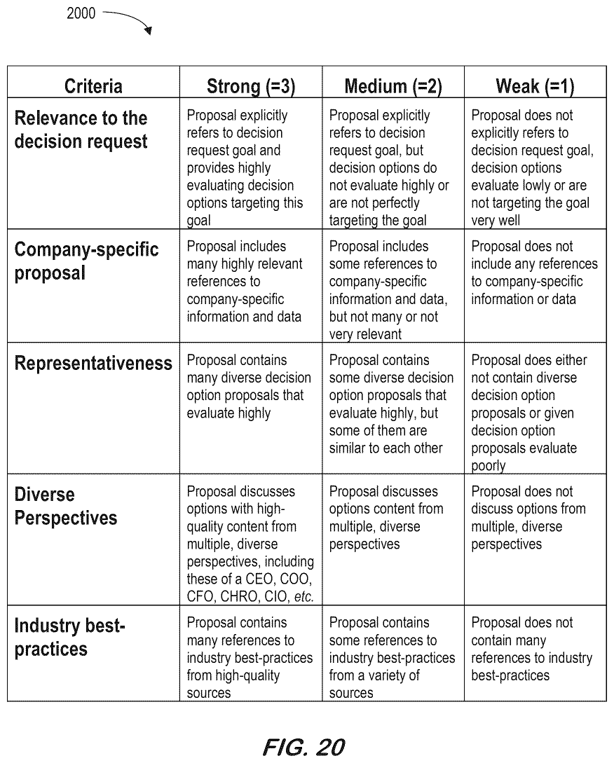

For example, FIG. 20 is a critique rubric 2000 according to some embodiments. While evaluating this rubric 2000 given the user decision request, the detailed decision request and decision suggestion, the agent 1950 keeps track of the highlights and weak spots of the decision suggestion and notes them down in the scratchpad 1970 along with its total evaluation. It summarizes its findings by providing the total score of the evaluation, a textual summary of its findings, and a list of suggestions for the other agents 1990 that can help them improve the overall result during the next round. The coordination agent may use this evaluation to decide if another round of refinement is necessary. For example, anything that evaluates significantly below a threshold value is typically not ready to be shown to the user or should only be shown with caution asking the user for additional input and guidance. Anything that evaluates higher than the threshold value can safely be shown to the user.

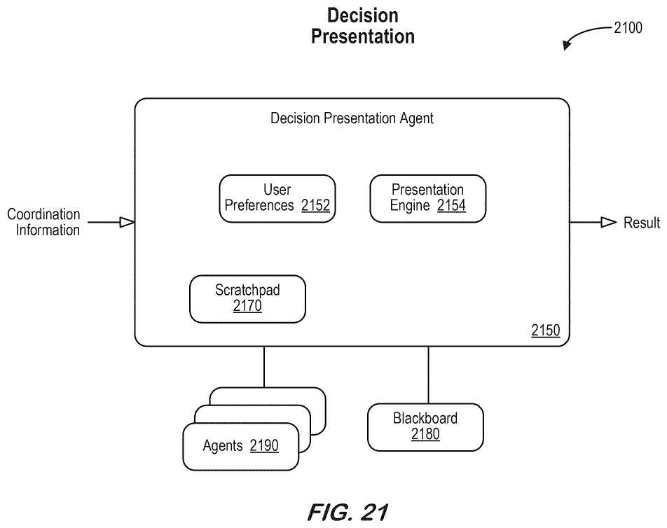

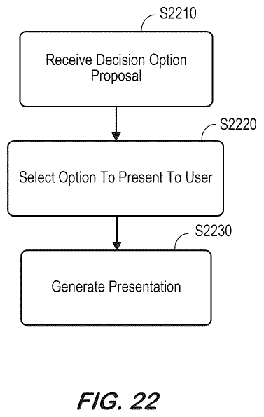

FIG. 21 is a decision presentation implementation 2100 in accordance with some embodiments. In particular, a decision presentation agent 2150 communicates with a shared blackboard 2180 and other AI agents 2190 to output a decision result. The decision presentation agent 2150 may utilize user preferences 2152, a presentation engine 2154, and/or a local scratchpad 2170 to perform this function. FIG. 22 is a decision presentation method according to some embodiments. At S2210, the decision presentation agent 2150 takes a given decision option suggestion, decides which of the evaluated options to present to the user at S2220, and generates a compelling presentation given a selected output channel at S2230.

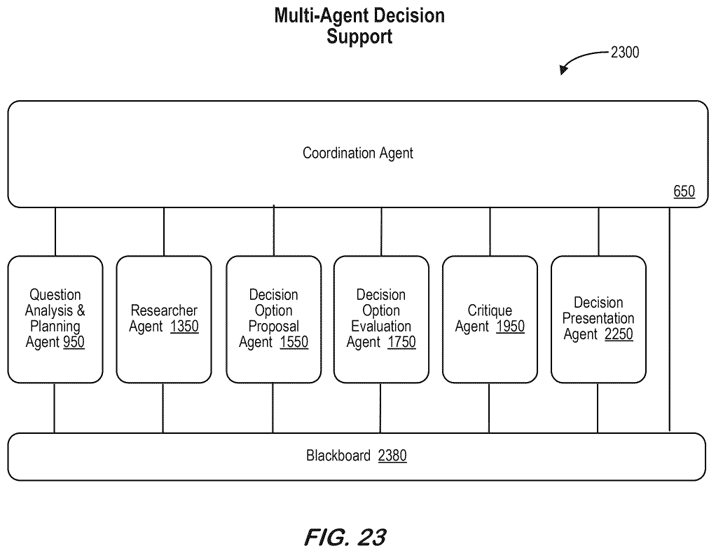

FIG. 23 is a detailed multi-agent decision support system 2300 in accordance with some embodiments. The system 2300 includes a coordination agent 650 that communicates with a question planning and analysis agent 950 to interpret decision support request and create a plan represented by a series of operations. The coordination agent 650 may also communicate with a research agent 1350 to analyze relevant data for detailed reasonings and a decision option suggestion agent 1550 to generate possible decision options. Moreover, the coordination agent 650 may communicate with a decision option evaluation agent 1750 to evaluate possible decision options using evaluation functions and a critique agent 1950 to analyze overall results in view of the decision support request and system decision-making criteria. In addition, the coordination agent 650 may communicate with a decision presentation agent 2250 to decide which of the possible decision options is presented to the user. All of these agents may communicate, for example, via a shared blackboard 2380.

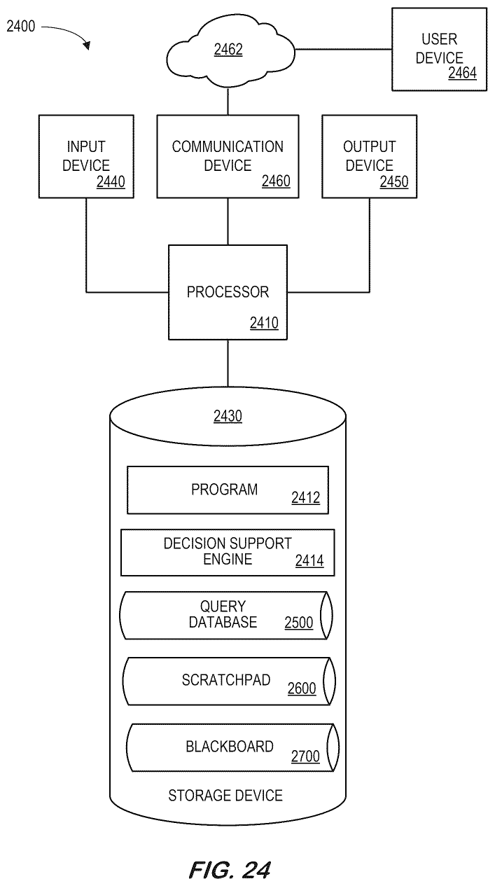

Embodiments described herein may be implemented using any number of different hardware configurations. For example, FIG. 24 is a block diagram of an apparatus or platform 2400 that may be, for example, associated with the system 100 of FIG. 1 (and/or any other system described herein). The platform 2400 comprises a processor 2410, such as one or more commercially available Central Processing Units (“CPUs”) in the form of one-chip microprocessors, coupled to a communication device 2460 configured to communicate via one or more communication networks. The communication device 2460 may be used to communicate, for example, with one or more user devices 2464 via a distributed computer network 2462. The platform 2400 further includes an input device 2440 (e.g., a computer mouse and/or keyboard to input data source information, user preferences, etc.) and/an output device 2450 (e.g., a computer monitor to render a display, transmit recommendations, evaluations, alerts, reports about decision results, etc.).

The processor 2410 also communicates with a storage device 2430. The storage device 2430 may comprise any appropriate information storage device, including combinations of magnetic storage devices (e.g., a hard disk drive), optical storage devices, mobile telephones, and/or semiconductor memory devices. The storage device 2430 stores a program 2412 and/or decision support engine 2414 for controlling the processor 2410. The processor 2410 performs instructions of the programs 2412, 2414 and thereby operates in accordance with any of the embodiments described herein. For example, the processor 2410 may receive a decision support request from a user and determine a series of operations associated with the decision support request. The processor 2410 may also arrange for the series of operations to be performed by a plurality of AI agents. Decision support information can then be presented to the user in response to the decision support request. According to some embodiments, the plurality of AI agents include a question planning and analysis agent, a research agent a decision option suggestion agent, a decision option evaluation agent, a critique agent, and/or a decision presentation agent.

The programs 2412, 2414 may be stored in a compressed, uncompiled and/or encrypted format. The programs 2412, 2414 may furthermore include other program elements, such as an operating system, clipboard application, a database management system, and/or device drivers used by the processor 2410 to interface with peripheral devices. As used herein, information may be “received” by or “transmitted” to, for example: (i) the platform 2400 from another device; or (ii) a software application or module within the platform 2400 from another software application, module, or any other source.

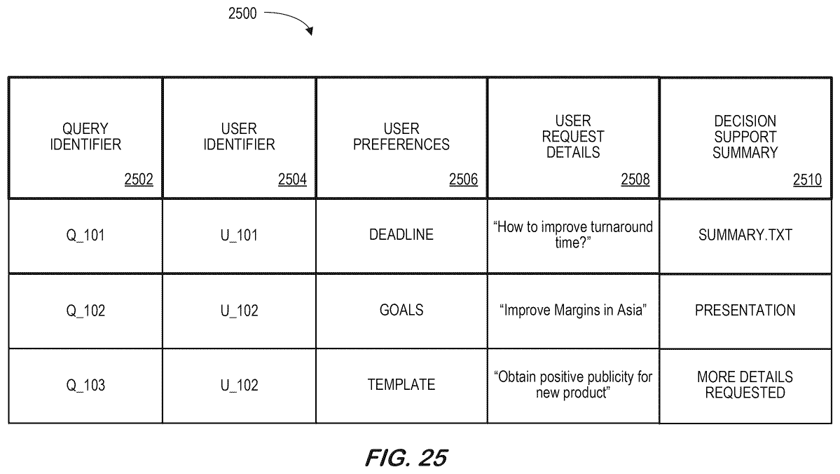

In some embodiments (such as the one shown in FIG. 24), the storage device 2430 further stores a query database 2500, a scratchpad 2600, and a blackboard 2700. An example of a database that may be used in connection with the platform 2400 will now be described in detail with respect to FIG. 25. Note that the databases described herein are only examples, and additional and/or different information may be stored therein. Moreover, various databases might be split or combined in accordance with any of the embodiments described herein.

Referring to FIG. 25, a table is shown that represents the query database 2500 that may be stored at the platform 2400 according to some embodiments. The table may include, for example, entries representing decision support requests received from user. The table may also define fields 2502, 2504, 2506, 2508, 2510 for each of the entries. The fields 2502, 2504, 2506, 2508, 2510 may, according to some embodiments, specify: a query identifier 2502, a user identifier 2504, user preferences 2506, user request details 2508, and a decision support summary 2510. The query database 2500 may be created and updated, for example, when a new query is received, an agent completes an operation, etc. The query identifier 2502 might be a unique alphanumeric label for a decision support request that has been received from the user identifier 2504. The user preferences 2506 might indicate a request deadline, goals, a preferred template, etc. The user request details 2508 might describe the decision that is needed, and the decision support summary 2510 might comprise a text file a presentation, a request for further details, etc.

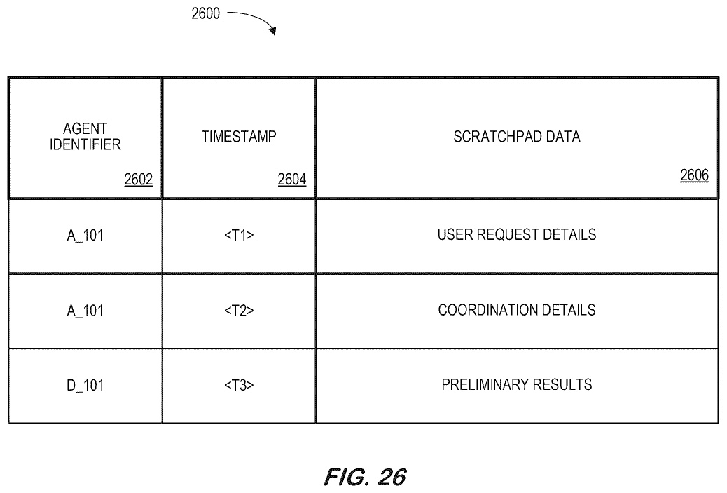

Referring to FIG. 26, a table is shown that represents the local scratchpad 2600 that may be stored at the platform 2400 according to some embodiments. The table may include, for example, entries representing information locally stored by an agent. The table may also define fields 2602, 2604, 2606 for each of the entries. The fields 2602, 2604, 2606 may, according to some embodiments, specify: an agent identifier 2602, a timestamp 2604, and scratchpad data 2606. The scratchpad 2600 may be created and updated, for example, when an agent receives instructions, completes an operation, etc. The agent identifier 2602 might be a unique alphanumeric label identifying agent associated with the scratchpad. The timestamp 2604 might indicate when an entry was written, and the scratchpad data 2606 might include details about a user request, coordination details, preliminary decision results, etc.

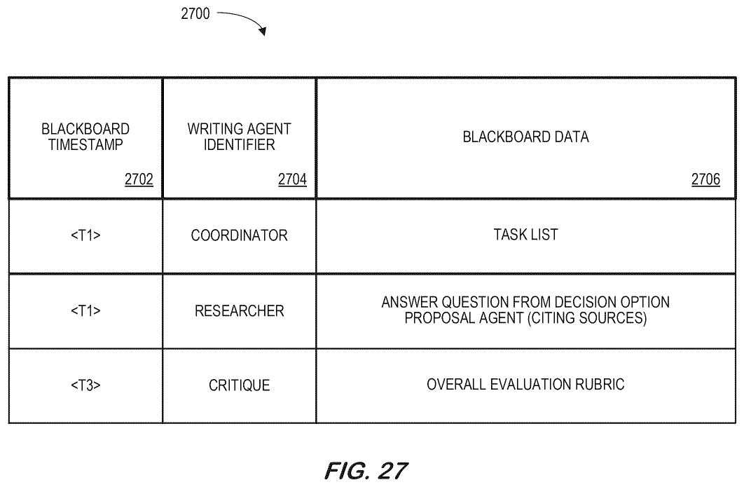

Referring to FIG. 27, a table is shown that represents the blackboard 2700 that may be stored at the platform 2400 according to some embodiments. The table may include, for example, entries representing shared information that is globally available in an AI multi-agent system. The table may also define fields 2702, 2704, 2706 for each of the entries. The fields 2702, 2704, 2706 may, according to some embodiments, specify: a blackboard timestamp 2702, a writing agent identifier 2704, and blackboard data 2706. The blackboard 2700 may be created and updated, for example, as a decision support request is processed, etc. The blackboard timestamp 2702 might be a unique alphanumeric label indicating when the writing agent identifier 2704 created the entry. The blackboard data 2706 might include the details being sharded by that agent.

In this way, embodiments may collaboratively exchange thoughts and ideas involving a range of specialized agents to significantly improve the quality of the proposed decision options. The improvement affects both the selection of presented decision options and the quality of those options. While simple prompts often produce results that are more general and superficial in nature, embodiments described herein may result in realistic and carefully refined decision options tailored to the decision need and context. Embodiments may have a significant impact on businesses and the economy more generally, potentially saving a system millions of dollars through better decision-making.

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

Although specific hardware and data configurations have been described herein, note that any number of other configurations may be provided in accordance with some embodiments of the present invention (e.g., some of the information associated with the databases described herein may be combined or stored in external systems). Moreover, although some embodiments are focused on particular types of use cases and documentation, any of the embodiments described herein could be applied to other types of use cases and documentation.

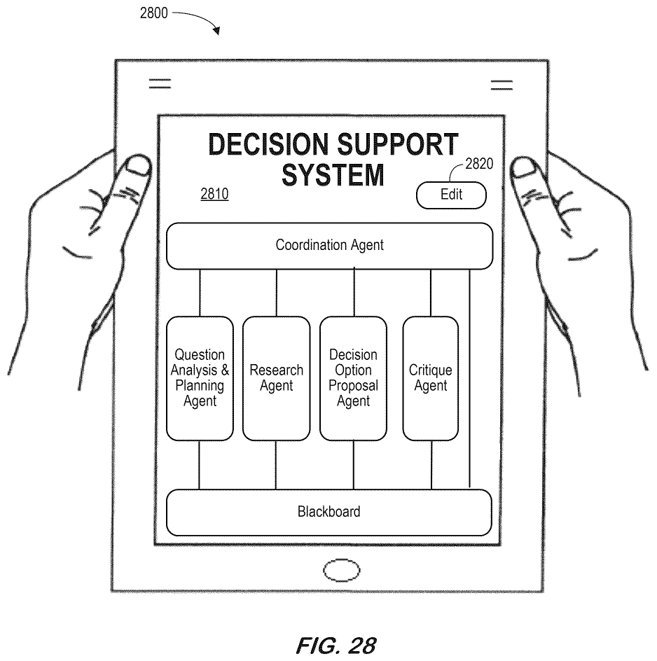

In addition, the displays shown herein are provided only as examples, and any other type of user interface could be implemented. For example, FIG. 28 illustrates a tablet computer 2800 providing a decision support user display 2810 according to some embodiments. The display 2810 might be used, for example, to inform the user about an AI multi-agent system. A user may interact with the display 2810, such as via an “Edit” icon 2820 (e.g., to change evaluation goals, analyze decision logic, etc.).

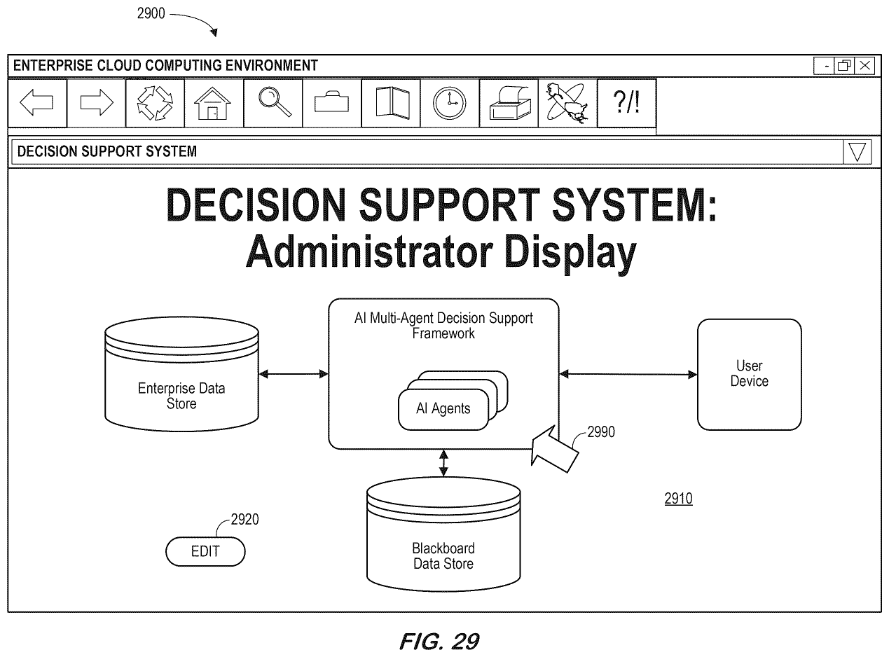

FIG. 29 is a decision support display 2900 in accordance with some embodiments. The display 2900 includes a graphical representation 2910 of a decision support framework in accordance with any of the embodiments described herein. Selection of an element on the display 2900 (e.g., via a touchscreen or computer pointer 2990) may result in display of a pop-up window containing more detailed information about that element and/or various options (e.g., to define how a data source interacts with the framework, how users communicate with the framework, etc.). Selection of an “Edit” icon 2920 may also let an operator or administrator adjust the operation of the system (e.g., to change a mapping to a data store, tune decision parameters, make changes to LLMs, etc.).

The present invention has been described in terms of several embodiments solely for the purpose of illustration. Persons skilled in the art will recognize from this description that the invention is not limited to the embodiments described but may be practiced with modifications and alterations limited only by the spirit and scope of the appended claims.

1. A system, comprising:
a blackboard data store containing electronic records that represent a plurality of Artificial Intelligence (“AI”) agent operation results associated with the system, each record including an operation identifier; and
a decision support platform, coupled to the blackboard data store and being associated with at least one Large Language Model (“LLM”), including:
a computer processor, and
a computer memory storing instructions that, when executed by the computer processor, cause the decision support platform to:
receive a decision support request from a user associated with the system,
determine, by a coordination agent, a series of operations associated with the decision support request,
arrange, by the coordination agent, for the series of operations to be performed by a plurality of AI agents, with operation results being recorded in the blackboard data store, and
present decision support information to the user in response to the decision support request.

2. The system of claim 1, wherein the plurality of AI agents include a question planning and analysis agent to interpret the decision support request and create a plan represented by series of operations.

3. The system of claim 1, wherein the plurality of AI agents include a research agent to analyze relevant data for detailed reasonings.

4. The system of claim 1, wherein the plurality of AI agents include a decision option suggestion agent to generate possible decision options.

5. The system of claim 1, wherein the plurality of AI agents include a decision option evaluation agent to evaluate possible decision options using evaluation functions.

6. The system of claim 1, wherein the plurality of AI agents include a critique agent to analyze overall results in view of the decision support request and system decision-making criteria.

7. The system of claim 1, wherein the plurality of AI agents include a decision presentation agent to decide which possible decision options are presented to the user.

8. A computer-implemented method, comprising:
receiving, by a computer processor of a decision support platform associated with at least one Large Language Model (“LLM”), a decision support request from a user associated with a system;
determining, by a coordination agent, a series of operations associated with the decision support request;
arranging, by the coordination agent, for the series of operations to be performed by a plurality of Artificial Intelligence (“AI”) agents, with operation results being recorded in a blackboard data store that contains electronic records that represent a plurality of AI agent operation results associated with the system, each record including an operation identifier; and
presenting decision support information to the user in response to the decision support request.

9. The method of claim 8, wherein the plurality of AI agents include a question planning and analysis agent to interpret the decision support request and create a plan represented by series of operations.

10. The method of claim 8, wherein the plurality of AI agents include a research agent to analyze relevant data for detailed reasonings.

11. The method of claim 8, wherein the plurality of AI agents include a decision option suggestion agent to generate possible decision options.

12. The method of claim 8, wherein the plurality of AI agents include a decision option evaluation agent to evaluate possible decision options using evaluation functions.

13. The method of claim 8, wherein the plurality of AI agents include a critique agent to analyze overall results in view of the decision support request and system decision-making criteria.

14. The method of claim 8, wherein the plurality of AI agents include a decision presentation agent to decide which possible decision options are presented to the user.

15. One or more non-transitory computer-readable media storing computer-executable instructions that, when executed by a computing system, cause the computing system to perform operations, comprising:
receiving, by a computer processor of a decision support platform associated with at least one Large Language Model (“LLM”), a decision support request from a user associated with a system;
determining, by a coordination agent, a series of operations associated with the decision support request;
arranging, by the coordination agent, for the series of operations to be performed by a plurality of Artificial Intelligence (“AI”) agents, with operation results being recorded in a blackboard data store that contains electronic records that represent a plurality of AI agent operation results associated with the system, each record including an operation identifier; and
presenting decision support information to the user in response to the decision support request.

16. The media of claim 15, wherein the plurality of AI agents include a question planning and analysis agent to interpret the decision support request and create a plan represented by a series of operations.

17. The media of claim 15, wherein the plurality of AI agents include a research agent to analyze relevant data for detailed reasonings.

18. The media of claim 15, wherein the plurality of AI agents include a decision option suggestion agent to generate possible decision options.

19. The media of claim 15, wherein the plurality of AI agents include a decision option evaluation agent to evaluate possible decision options using evaluation functions.

20. The media of claim 15, wherein the plurality of AI agents include:
a critique agent to analyze overall results in view of the decision support request and system decision-making criteria; and
a decision presentation agent to decide which possible decision options are presented to the user.
